(19) United States
(12) Patent Application Publication
(10) Pub. No.: US 2020/0168380 A1
(43) Pub. Date: May 28, 2020

(54) PRIVACY FILM USED IN A COMPUTER SCREEN

(71) Applicant: Keeline Pi, Zhangshu City (CN)

(72) Inventor: Keeline Pi, Zhangshu City (CN)

(21) Appl. No.: 16/675,231

(22) Filed: Nov. 6, 2019

(30) Foreign Application Priority Data
Nov. 28, 2018 (CN) 201821969675.7

(51) Int. Cl. H01F 7/02; B32B 27/36; B32B 27/08

(52) U.S. Cl. CPC H01F 7/0252; B32B 27/36; B32B 27/08; B32B 2457/20; B32B 2250/244; B32B 2307/208; B32B 2250/03

(57) ABSTRACT

The present application disclosed herein relates to computer peripheral accessories, in particular, to a privacy film used in a computer screen, comprising a first film layer, a second film layer, a magnetic adsorption piece; the first film layer and/or the second film layer is a privacy film layer, the magnetic adsorption piece is disposed at an upper end portion of the first film layer and the second film layer and is located therebetween, and the first film layer, the magnetic adsorption piece, and the second film layer are integrally pressed to form the privacy film, and the magnetic adsorption piece is adsorbed to the magnetic body when the privacy film is attached to the computer screen, to complete the mounting, which is quite convenient. When someone sees the computer screen on the side, he/she cannot see the content on the screen, so it can protect privacy.

### CROSS REFERENCE TO RELATED APPLICATIONS

The present application claims the benefit of Chinese Utility Model Application No. 201821969675.7 filed on Nov. 28, 2018, the contents of which are incorporated herein by reference in their entirety.

### TECHNICAL FIELD

The present application relates to computer peripheral accessories, in particular, to a privacy film used in a computer screen.

### BACKGROUND ART

A kind of electronic product privacy films currently used, such as computer privacy films, are disposed on the surface of the computer screens to prevent others from seeing the content in the computer screen from the side. However, the existing block privacy films are complicated to bond and bubbles and other problems may happen, therefore it is necessary to squeeze air bubbles, which can easily cause wear of computer privacy film or computer screen; in addition, this kind of computer privacy film cannot be disassembled repeatedly. If privacy films with glues are used, they will not be used again after disassembled, thus causing unnecessary losses. Therefore, it is urgent to have a kind of novel privacy films that can be easily disassembled.

### SUMMARY

In order to solve the above problems, an object of the present invention is to provide a privacy film used in a computer screen that can be easily disassembled.

The object of this application is achieved by the following technical solutions:

The present application patent provides a privacy film used in a computer screen, wherein a magnetic body is disposed inside the upper end of the computer screen, wherein the privacy film comprises: a first film layer, a second film layer, a magnetic adsorption piece; the first film layer and/or the second film layer is a privacy film layer, the magnetic adsorption piece is disposed at an upper end portion of the first film layer and the second film layer and is located therebetween, and the first film layer, the magnetic adsorption piece, and the second film layer are integrally pressed to form the privacy film, and the magnetic adsorption piece is adsorbed to the magnetic body when the privacy film is attached to the computer screen.

Further, the privacy film further comprises a third film layer, and the magnetic adsorption piece and the upper end portion of the third film layer are connected to form an intermediate film layer, the first film layer, the intermediate film layer and the second film layer are integrally pressed to form the privacy film.

Further, the first film layer is provided with a first mounting groove on a side surface facing to the magnetic adsorption piece, and the magnetic adsorption piece is disposed behind the first mounting groove, and the first film layer, the magnetic adsorption piece, and the second film layer are integrally pressed to form the privacy film.

Further, the depth of the first mounting groove is the same as the thickness of the magnetic adsorption piece.

Further, the first film layer is provided with a first mounting groove on a side surface facing to the magnetic adsorption piece, the second film layer is provided with a second mounting groove on a side surface facing to the magnetic adsorption piece, and the magnetic adsorption piece is disposed behind the first mounting groove and the second mounting groove, and the first film layer, the magnetic adsorption piece, and the second film layer are integrally pressed to form the privacy film.

Further, the sum of the groove depths of the first mounting groove and the second mounting groove is the same as the thickness of the magnetic adsorption piece.

Further, the magnetic adsorption piece comprises a strip-shaped metal sheet.

Further, the strip-shaped metal sheet comprises a strip-shaped iron sheet.

Further, the number of the magnetic adsorption pieces is one, and the first film layer, the magnetic adsorption piece, and the second film layer are provided with avoidance slots to avoid a camera component at the upper end of the computer screen.

Further, the number of the magnetic adsorption pieces is two, and the two magnetic adsorption pieces are symmetrically spaced, and the opposite end portion of the two magnetic adsorption pieces is set as a beveled edge, and an avoidance space is formed between two beveled edges of the two magnetic adsorption pieces to avoid a camera component at the upper end of the computer screen, and the first film layer and the second film layer are provided with avoidance slots to avoid the camera component at the upper end of the computer screen.

In the present application, the magnetic adsorption piece is disposed at an upper end portion of the first film layer and the second film layer and is located therebetween, and the first film layer, the magnetic adsorption piece, and the second film layer are integrally pressed to form the privacy film, and the magnetic adsorption piece is adsorbed to the magnetic body when the privacy film is attached to the computer screen, to complete the mounting, which is quite convenient. When someone sees the computer screen on the side, he/she cannot see the content on the screen, so it can protect privacy; in addition, it is simple, convenient and practical.

### BRIEF DESCRIPTION OF THE DRAWINGS

The drawings are intended to provide a further understanding of the application and constitute a part of the present application. The examples herein and description are intended to be illustrative of the present application and are not intended to limit the application. In the drawings:

FIG. 1 is a structural diagram according to an embodiment of a privacy film used in a computer screen of the present application;

FIG. 2 is an exploded view of FIG. 1;

FIG. 3 is an exploded view showing the structure of another embodiment of the privacy film used in a computer screen of the present application;

FIG. 4 is an exploded view showing the structure of another embodiment of the privacy film used in a computer screen of the present application;

Reference signs: 1, first film layer; 2, second film layer; 3, magnetic adsorption piece; 4, third film layer; 5, first mounting groove; 6, second mounting groove; 7, avoidance slot; 8, beveled edge; 9, avoidance space.

### DETAILED DESCRIPTION OF THE EMBODIMENTS

The technical solutions of embodiments herein will be clearly and completely described in the following with reference to the accompanying drawings, to allow technicians skilled in the art can understand them. Apparently, the embodiments described herein are merely a part of rather than all of the embodiments of the present application. All other embodiments obtained by those skilled in the art based on the embodiments of the present invention without creative work shall fall within the scope of protection of the present application.

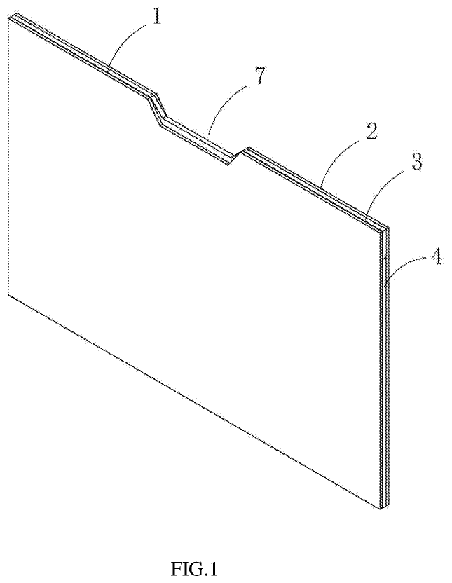

As shown in FIG. 1 to FIG. 4, a privacy film used in a computer screen is provided, wherein a magnetic body is disposed inside the upper end of the computer screen, the magnetic body is generally a magnet, and the privacy film comprises: a first film layer 1, a second film layer 2, a magnetic adsorption piece 3; the first film layer 1 and/or second film layer 2 is a privacy film layer, and another layer which is not a private film layer may be a PET material layer, preferably the first film layer 1 is a privacy film layer, and the second film layer 2 is a PET material layer, the magnetic adsorption piece 3 is disposed at an upper end portion of the first film layer 1 and the second film layer 2 and is located therebetween, and the first film layer 1, the magnetic adsorption piece 3, and the second film layer 2 are integrally pressed to form the privacy film, and the magnetic adsorption piece 3 is adsorbed to the magnetic body when the privacy film is attached to the computer screen.

For the privacy film used in a computer screen of the present application, the magnetic adsorption piece is adsorbed to the magnetic body when the privacy film is attached to the computer screen, to complete the mounting, which is quite convenient. When someone sees the computer screen on the side, he/she cannot see the content on the screen, so it can protect privacy; in addition, it is simple, convenient and practical.

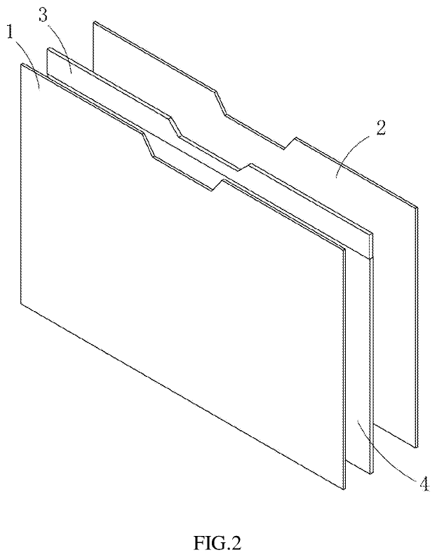

In a preferred embodiment, referring to FIGS. 1-2, the privacy film further comprises a third film layer 4, and the magnetic adsorption piece 3 and the upper end portion of the third film layer 4 are connected to form an intermediate film layer, the first film layer 1, the intermediate film layer and the second film layer 2 are integrally pressed to form the privacy film. The third film layer 4 is used as a lining, the three film layers are integrally pressed to form the privacy film with more uniform thickness. This third film layer 4 may be a privacy film layer or a PET material layer.

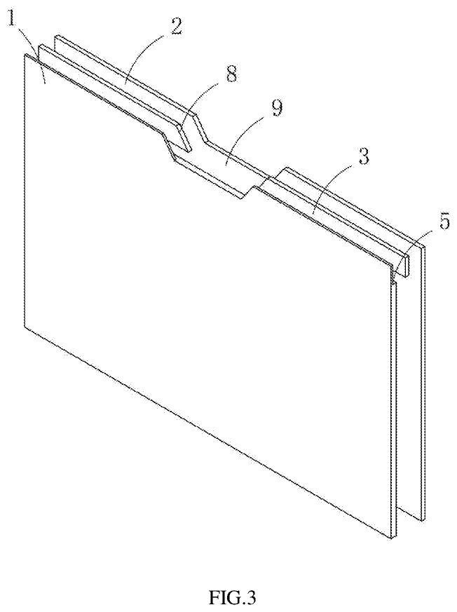

In a preferred embodiment, referring to FIG. 3, the first film layer 1 is provided with a first mounting groove 5 on a side surface facing to the magnetic adsorption piece 3, and the magnetic adsorption piece 3 is disposed behind the first mounting groove 5, and the first film layer 1, the magnetic adsorption piece 3, and the second film layer 2 are integrally pressed to form the privacy film. The magnetic adsorption piece 3 is mounted in the first mounting groove 5 so that the integrated privacy film is more uniform in thickness.

In a preferred embodiment, the depth of the first mounting groove 5 is the same as the thickness of the magnetic adsorption piece 3, so that the integrally formed privacy film has the same thickness.

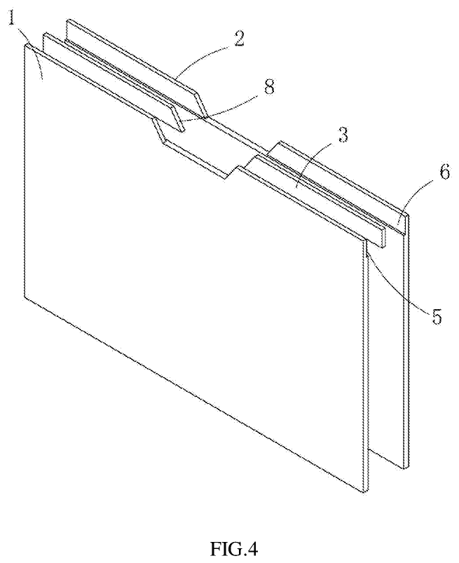

In a preferred embodiment, referring to FIG. 4, the first film layer 1 is provided with a first mounting groove 5 on one side surface facing to the magnetic adsorption piece 3, and the second film layer 2 is provided with a second mounting groove 6 on a side surface facing to the magnetic adsorption piece 3, and the magnetic adsorption piece 3 is disposed behind the first mounting groove 5 and the second mounting groove 6. The first film layer 1, the magnetic adsorption piece 3, and the second film layer 2 are integrally pressed to form a privacy film. The magnetic adsorption piece 3 is mounted in the first mounting groove 5 and the second mounting groove 6, so that the integrally formed privacy film is more uniform in thickness.

In a preferred embodiment, the sum of the groove depths of the first mounting groove 5 and the second mounting groove 6 is the same as the thickness of the magnetic adsorption piece 3, so that the integrally formed privacy film is uniform in thickness.

In a preferred embodiment, the magnetic adsorption piece 3 comprises a strip-shaped metal sheet, the strip-shaped metal sheet is more easily available, with low cost, and the area formed by the strip-shaped metal sheet is larger, having a lager adsorption force with the magnet in the computer screen.

In a preferred embodiment, the strip-shaped metal sheet comprises a strip-shaped iron sheet, and the strip-shaped iron sheet has a better adsorption effect with the magnet in the computer screen.

In a preferred embodiment, referring to FIG. 2, the number of the magnetic adsorption pieces 3 is one, and the first film layer 1, the magnetic adsorption piece 3, and the second film layer 2 are provided with avoidance slots 7 to avoid a camera component at the upper end of the computer screen, to avoid the camera or sensor on the computer.

In a preferred embodiment, referring to FIGS. 3-4, the number of the magnetic adsorption pieces 3 is two, and the two magnetic adsorption pieces 3 are symmetrically spaced, and the opposite end portion of the two magnetic adsorption pieces 3 is set as a beveled edge 8, and an avoidance space 9 is formed between two beveled edges 8 of the two magnetic adsorption pieces to avoid a camera component at the upper end of the computer screen, and the first film layer 1 and the second film layer 2 are provided with avoidance slots 7 to avoid the camera component at the upper end of the computer screen, to avoid the camera or sensor on the computer.

The above description is only preferred embodiments of the present application. It should be noted that those skilled in the art can make a plurality of improvements and modifications without departing from the principles of the present application, and these improvements and modifications made should also fall within the scope of protection of the present application.

What is claimed is:

1. A privacy film used in a computer screen, wherein a magnetic body is disposed inside the upper end of the computer screen, wherein the privacy film comprises: a first film layer, a second film layer, a magnetic adsorption piece;
the first film layer and/or the second film layer is a privacy film layer, the magnetic adsorption piece is disposed at an upper end portion of the first film layer and the second film layer and is located therebetween, and the first film layer, the magnetic adsorption piece, and the second film layer are integrally pressed to form the privacy film, and the magnetic adsorption piece is adsorbed to the magnetic body when the privacy film is attached to the computer screen.

2. The privacy film used in a computer screen according to claim 1, wherein the privacy film further comprises a third film layer, and the magnetic adsorption piece and the upper end portion of the third film layer are connected to form an intermediate film layer, the first film layer, the intermediate film layer and the second film layer are integrally pressed to form the privacy film.

3. The privacy film used in a computer screen according to claim 1, wherein the first film layer is provided with a first mounting groove on a side surface facing to the magnetic adsorption piece, and the magnetic adsorption piece is disposed behind the first mounting groove, and the first film layer, the magnetic adsorption piece, and the second film layer are integrally pressed to form the privacy film.

4. The privacy film used in a computer screen according to claim 3, wherein the depth of the first mounting groove is the same as the thickness of the magnetic adsorption piece.

5. The privacy film used in a computer screen according to claim 1, wherein the first film layer is provided with a first mounting groove on a side surface facing to the magnetic adsorption piece, the second film layer is provided with a second mounting groove on a side surface facing to the magnetic adsorption piece, and the magnetic adsorption piece is disposed behind the first mounting groove and the second mounting groove, and the first film layer, the magnetic adsorption piece, and the second film layer are integrally pressed to form the privacy film.

6. The privacy film used in a computer screen according to claim 5, wherein the sum of the groove depths of the first mounting groove and the second mounting groove is the same as the thickness of the magnetic adsorption piece.

7. The privacy film used in a computer screen according to claim 1, wherein the magnetic adsorption piece comprises a strip-shaped metal sheet.

8. The privacy film used in a computer screen according to claim 7, wherein the strip-shaped metal sheet comprises a strip-shaped iron sheet.

9. The privacy film used in a computer screen according to claim 1, wherein the number of the magnetic adsorption pieces is one, and the first film layer, the magnetic adsorption piece, and the second film layer are provided with avoidance slots to avoid a camera component at the upper end of the computer screen.

10. The privacy film used in a computer screen according to claim 1, wherein the number of the magnetic adsorption pieces is two, and the two magnetic adsorption pieces are symmetrically spaced, and the opposite end portion of the two magnetic adsorption pieces is set as a beveled edge, and an avoidance space is formed between two beveled edges of the two magnetic adsorption pieces to avoid a camera component at the upper end of the computer screen, and the first film layer and the second film layer are provided with avoidance slots to avoid the camera component at the upper end of the computer screen.
